(19) United States
(12) Patent Application Publication
(10) Pub. No.: US 2014/0365817 A1
(43) Pub. Date: Dec. 11, 2014

(54) DATA PRESERVATION PROCESSING DEVICE, RAID CONTROLLER, DATA PRESERVATION PROCESSING SYSTEM, DATA PRESERVATION PROCESSING METHOD AND RECORDING MEDIUM THEREFOR

(71) Applicant: NEC Corporation, Tokyo (JP)

(72) Inventor: JUNTA TANAKA, Tokyo (JP)

(73) Assignee: NEC Corporation, Tokyo (JP)

(21) Appl. No.: 14/295,793

(22) Filed: Jun. 4, 2014

(30) Foreign Application Priority Data
Jun. 10, 2013 (JP) 2013-121501

(51) Int. Cl. G06F 11/20

(52) U.S. Cl. CPC G06F 11/2094
USPC 714/6.21

(57) ABSTRACT

Disclosed is a data preservation processing device which effectively realizes data preservation processing on an occurrence of a bit error.

The data preservation processing device includes: a memory monitoring and detection unit which detects a memory being in an abnormal state, the memory being included in a controller which is communicably connected with a storage device and temporarily storing data which is inputted in the storage device; and a data protection unit which changes a write policy concerning the storage device to write-through when the memory monitoring and detection unit detects the memory being in the abnormal state.

This application is based upon and claims the benefit of priority from Japanese Patent Application No. 2013-121501 filed on Jun. 10, 2013, the disclosure of which is incorporated herein in its entirety by reference.

### TECHNICAL FIELD

The present invention relates to a preservation technology of data.

### BACKGROUND ART

Volume of data which is created and managed in a company or the like continues to increase because of the rapid spread of PCs (Personal Computers) in recent years. Therefore, importance of data preservation becomes higher. Consequently, RAID (Redundant Arrays of Inexpensive Disks) is widely used as a technology which builds and operates a high speed and highly reliable disk system.

Generally, in a structure of the RAID, a RAID controller which carries out a parity operation and the like makes a disk array, which is a combination of a plurality of hard disks, function meaningfully. For example, the RAID controller makes the disk array including hard disks function as one virtual hard disk. The RAID controller includes a CPU (Central Processing Unit; main control device) which executes various arithmetic processing and the like and a memory (cache memory) which keeps data temporarily between the CPU and the disk array.

When a memory with ECC (Error Correction Code) function is installed in the RAID controller, by the ECC function, it is possible to detect an error of up to 1 bit per unit block, and to recover the detected error. Accordingly, even if an error of up to 1 bit per unit block occurs in the memory equipped in the RAID controller, it is possible to preserve cache data in the memory.

By the ECC function, it is possible to detect occurrence of an error of no smaller than 2 bits per unit block. However, when an error of no smaller than 2 bits per unit block occurs, the RAID controller is controlled so as to stop functioning. Therefore, when an error of no smaller than 2 bits per unit block occurs, the cache data in the memory is not always be preserved. That is, by the ECC function, although occurrence of an error of no smaller than 2 bits per unit block can be detected, the detected error is not recovered. Therefore, when an error of no smaller than 2 bits per unit block occurs, the data in the memory is not preserved and is discarded.

A data write policy for a storage device including the above-mentioned disk array may be write-back or write-through. The data write policy of write-back is a data write policy by which data is written in the cache memory temporarily, and when a predetermined condition is satisfied, the data being stored in the cache memory is written in the storage device. The data write policy of write-through is a data write policy by which data is written simultaneously in the cache memory and the disk array. In the following explanation, the data write policy is also described simply as “write policy.” An error of 1 bit per unit block is also described as a “1 bit error.” An error of 2 bits per unit block is also described as a “2 bits error.” An error of no smaller than 2 bits per unit block is also described as a “plural-bits error.”

In an environment where the write policy to write data in the disk array being controlled by a RAID controller is set to the write-back, when a plural-bits error occurs, whole data is discarded from the cache memory. Data which is stored in the cache memory and is not yet written in the disk array is also discarded.

In addition, volume of the cache memory installed in a RAID controller tends to increase in recent years. Accordingly, the volume of data which is discarded when a plural-bits error occurs also increases. Therefore, a technology which realizes preservation of the cache data effectively while holding write performance obtained by the write policy of write-back is required.

Reliability of a memory installed in a RAID controller is improving together with progress of the hardware. However, it is difficult to suppress completely occurrence of a bit error caused by noise or the like during signal transmission. Therefore, a technology which prevents data loss which is caused by a fault of the memory when the write policy of write-back is used is required. An example of a related technology which preserves data is disclosed, for example, in the below-mentioned Patent documents 1 and 2.

Patent document 1 discloses a control method of a disk array device which includes a cache memory, a flash memory, a first control module, a second control module, and a disk array. The cache memory is a volatile memory. Data in the cache memory is saved in the flash memory. A battery functions when a main power source stops. Each of the first control module and the second control module includes a CPU which carries out processing of writing data in the cache memory and the flash memory. Each of the control modules write data in the disk array, and read the data out. In the technology disclosed in Patent document 1, potential for saving data in the cache memory is derived on the basis of the battery capacity which is related to one of the control modules and available area of the flash memory used for saving. And on the basis of the derived potential for saving data and the state of the other control module, the write policy of writing data in the disk array device is determined.

In Patent document 2, a disk array system in which two clusters, each of which includes a memory controller containing a cache memory, share a disk device is disclosed. In the technology disclosed in Patent document 2, both of the memory controllers determine addresses to store data independently of each other. When one of the memory controllers becomes unavailable, recovery processing of data is carried out on the basis of the determined addresses.

### CITATION LIST

[Patent document 1] Japanese Unexamined Patent Application Publication No. 2011-164780

[Patent document 2] Japanese Unexamined Patent Application Publication No. 2010-092318

### SUMMARY

One of exemplary objects of the present invention is to provide a data preservation processing device which effectively realizes data preservation processing depending on an occurrence state of a bit error.

A data preservation processing device according to an exemplary aspect of the invention includes: a memory monitoring and detection unit which detects a memory being in an abnormal state, the memory being included in a controller which is communicably connected with a storage device and temporarily storing data which is inputted in the storage device; and a data protection unit which changes a write policy concerning the storage device to write-through when the memory monitoring and detection unit detects the memory being in the abnormal state.

A data preservation processing method according to an exemplary aspect of the invention includes: detecting a memory being in an abnormal state, the memory being included in a controller which is communicably connected with a storage device and temporarily storing data which is inputted in the storage device; and changing a write policy concerning the storage device to write-through when detecting the memory being in the abnormal state.

A non-transitory computer-readable recording medium according to an exemplary aspect of the invention stores a data preservation processing program which makes a computer operate as: a memory monitoring and detection unit which detects a memory being in an abnormal state, the memory being included in a controller which is communicably connected with a storage device and temporarily storing data which is inputted in the storage device; and a data protection unit which changes a write policy concerning the storage device to write-through when the memory monitoring and detection unit detects the memory is in the abnormal state.

### BRIEF DESCRIPTION OF THE DRAWINGS

Exemplary features and advantages of the present invention will become apparent from the following detailed description when taken with the accompanying drawings in which:

FIG. 1 is a block diagram showing a RAID controller and a structure of a data preservation processing system including the RAID controller according to a first exemplary embodiment of the present invention;

FIG. 2 is a block diagram showing a structure of a data preservation processing device having a similar structure compared with the data preservation processing unit shown in FIG. 1;

FIG. 3 is a flow chart showing operation of the data preservation processing system shown in FIG. 1;

FIG. 4 is a block diagram showing a RAID controller and a structure of a data preservation processing system including the RAID controller according to a second exemplary embodiment of the present invention;

FIG. 5 is a block diagram showing a state where a data preservation processing program is read by a main control device in the RAID controller shown in FIG. 4;

FIG. 6 is a block diagram including a flow when the main control device shown in FIG. 4 detects 1 bit error by the data preservation processing program which is read;

FIG. 7 is a block diagram including a flow when the main control device shown in FIG. 4 detects a failure of a main memory device by the data preservation processing program which is read;

FIG. 8 is a block diagram showing a RAID controller and a structure of a data preservation processing system including the RAID controller according to a third exemplary embodiment of the present invention;

FIG. 9 is a block diagram illustrating an example of a structure of a data preservation processing device 64 according to a fourth exemplary embodiment of the present invention; and

FIG. 10 is a figure illustrating an example of a structure of a computer 1000 by which a device according to each of the exemplary embodiments of the present invention can be realized.

### EXEMPLARY EMBODIMENT

Hereinafter, an exemplary embodiment of the present invention will be explained in detail with reference to drawings.

### First Exemplary Embodiment

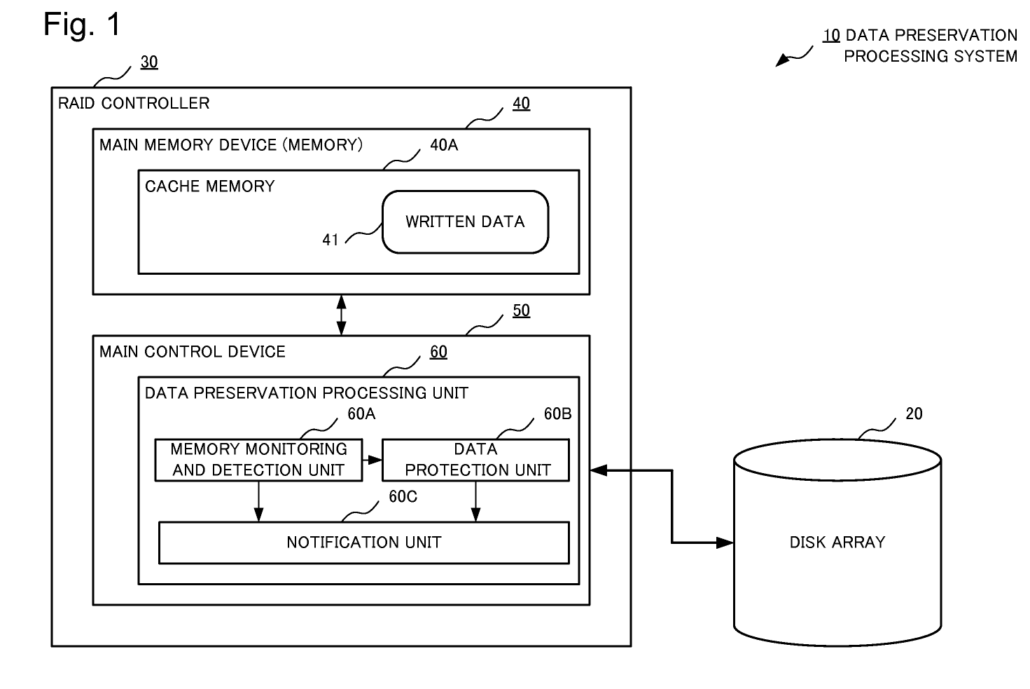

A RAID controller and a data preservation processing system including the RAID controller according to a first exemplary embodiment of the present invention will be explained on the basis of FIG. 1 to FIG. 3.

(Overall Structure)

A data preservation processing system 10 includes a disk array 20, in which hard disks are combined, and a RAID controller 30 which makes the disk array 20 function as RAID. Accordingly, the data preservation processing system 10 improves speed and reliability of the hard disk and realizes effective data preservation processing.

The RAID controller 30 is includes a main memory device (memory) 40 and a main control device 50. The main memory device 40 includes at least a cache memory 40A in which inputted data from outside is stored temporarily. The main control device 50 carries out control of the disk array 20 and preservation processing of the data stored in the main memory device 40. The data which is inputted from outside is data which is inputted from a device which is not included in the data preservation processing system. The data which is inputted from outside is, for example, data which is wrote in the disk array 20 via the RAID controller by an upper level device (not illustrated, and also described as an “outside unit”) which uses the disk array 20 as a storage device.

As shown in FIG. 1, written data 41 which is inputted from outside and written in the cache memory 40A is stored in the main memory device 40. The written data 41 is data which changes at any time according to data inputted from outside, a situation of writing data in the disk array 20, and the like.

The main control device 50 includes an arithmetic operation unit (not illustrated) which carries out various operation.

The main control device 50 according to the exemplary embodiment includes a data preservation processing unit 60. The data preservation processing unit 60 monitors the main memory device 40, and executes preservation processing of data which is stored temporarily in the cache memory 40A.

The data preservation processing unit 60 includes a memory monitoring and detection unit 60A and a data protection unit 60B. The memory monitoring and detection unit 60A detects a 1 bit error in the main memory device 40, and monitors a frequency of occurrence of 1 bit errors. When the frequency of occurrence exceeds a predetermined threshold (that is, is higher than the threshold value), the memory monitoring and detection unit 60A detects the main memory device 40 being in an abnormal state (that is, detects a failure), which is also described as “the memory monitoring and detection unit 60A detects the abnormal state.” When the memory monitoring and detection unit 60A detects the abnormal state, the data protection unit 60B saves, in the disk array 20, the written data 41 which is stored temporarily in the cache memory 40A included in the main memory device 40. When the memory monitoring and detection unit 60A detects the abnormal state, moreover, the data protection unit 60B changes (that is, switches) a write policy concerning the disk array 20 to write-through if the write policy is write-back. As mentioned above, a 1 bit error represents an error of 1 bit per unit block. The write policy may be write-back or write-through as mentioned above.

The data preservation processing unit 60 includes a notification unit 60C having a notification function of detection result and a notification function of mode change. When the memory monitoring and detection unit 60A detects a 1 bit error in the main memory device 40, the notification unit 60C notifies an upper level device (or, upper level SW (Software), not illustrated) or an administrator (not illustrated) of the detection of a 1 bit error by the notification function of detection result. When the data protection unit 60B changes the write policy, the notification unit 60C notifies the upper level device or the administrator of the change in the write policy by the notification function of mode change.

That is, when a 1 bit error is detected, the memory monitoring and detection unit 60A sends a signal which relates to detection of a 1 bit error to the notification unit 60C. When the write policy is changed, the data protection unit 60B sends a signal which relates to the change of the write policy to the notification unit 60C.

The memory monitoring and detection unit 60A determines, by comparing a predetermined threshold and a frequency of occurrence obtained by the monitoring after the above-mentioned detection of the 1 bit error, whether the frequency of occurrence exceeds the threshold value (that is, whether the frequency of occurrence is higher than the threshold value). As a result of determining, when the frequency of occurrence exceeds the threshold value, the memory monitoring and detection unit 60A sends a signal representing a failure of the main memory device 40 to the data protection unit 60B.

When the signal representing a failure of the main memory device 40 is received from the memory monitoring and detection unit 60A, the data protection unit 60B identifies the present data write policy concerning the disk array 20. In addition, when the identified write policy is write-back, the data protection unit 60B carries out processing of writing the written data 41 which is stored temporarily in the main memory device 40 to the disk array 20.

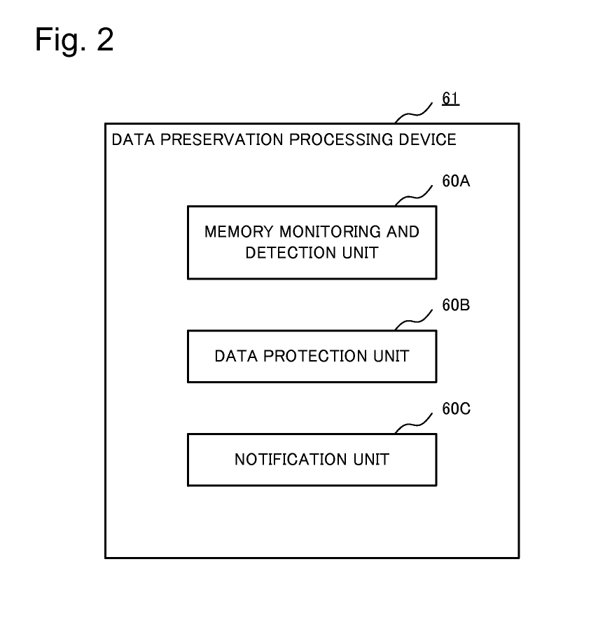

In the above-mentioned structure shown in FIG. 1, the main control device 50 includes the data preservation processing unit 60 which executes the preservation processing of the written data 41. The data preservation processing system 10 may include a data preservation processing device 61 with the same structure as the data preservation processing unit 60, where the data preservation processing device 61 exists outside the main control device 50. As shown in FIG. 2, the data preservation processing device 61 includes the memory monitoring and detection unit 60A, the data protection unit 60B and the notification unit 60C, in the same way as the data preservation processing unit 60. In this case, it is not necessary that the data preservation processing device 61 is included in the RAID controller 30. The data preservation processing device 61 may exist outside the RAID controller 30.

(Explanation of Operation)

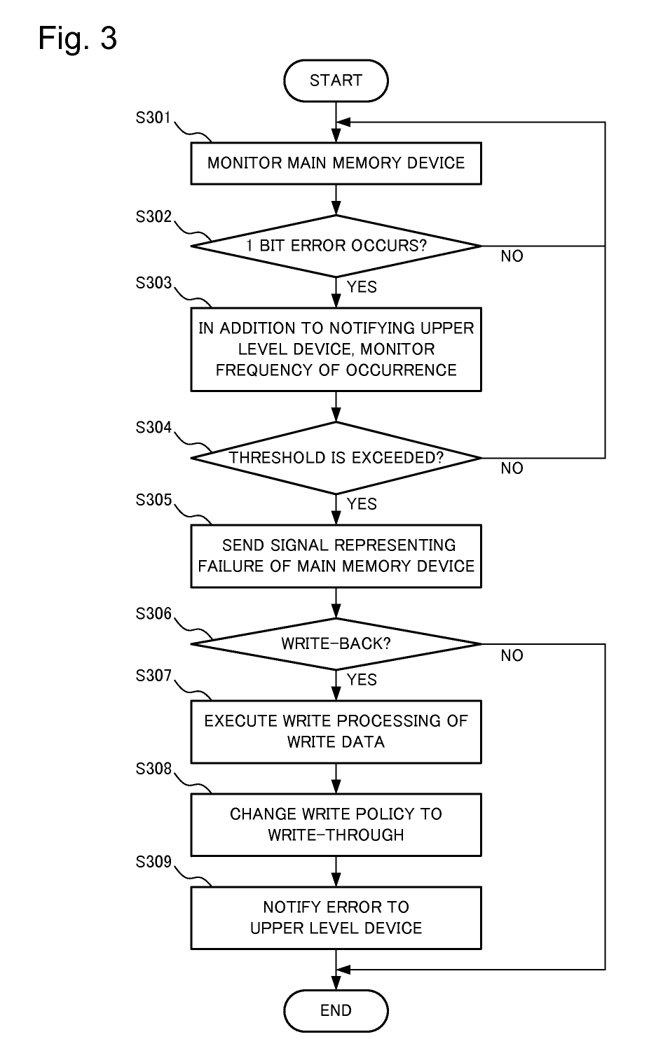

Next, operation which relates to the RAID controller 30 and the data preservation processing system 10 including the RAID controller shown in FIG. 1 will be explained on the basis of the flow chart shown in FIG. 3.

The memory monitoring and detection unit 60A monitors a state of the main memory device 40 (FIG. 3: Step S301). When occurrence of a 1 bit error in the main memory device 40 is detected (FIG. 3: “Yes” in Step S302), the memory monitoring and detection unit 60A sends a signal which represents detection of occurrence of a 1 bit error to the notification unit 60C. In addition, the memory monitoring and detection unit 60A starts to monitor the frequency of occurrence of 1 bit errors (FIG. 3: Step S303).

In that case, the notification unit 60C further notifies the upper level device or the administrator of the occurrence of a 1 bit error (FIG. 3: Step S303).

When occurrence of a 1 bit error in the main memory device 40 is not detected (FIG. 3: “Yes” in Step S302), the memory monitoring and detection unit 60A continues to monitor the state of the main memory device 40 (FIG. 3: Step S301).

Next, the memory monitoring and detection unit 60A determines, by comparing the predetermined threshold and the frequency of occurrence obtained by monitoring after a 1 bit error is detected, whether the frequency of occurrence exceeded the threshold (FIG. 3: Step S304).

As a result of determining, when the frequency of occurrence exceeds the threshold value (FIG. 3: “Yes” in Step S304), the memory monitoring and detection unit 60A estimates that the main memory device 40 is in the abnormal state (that is, not in the normal state). The memory monitoring and detection unit 60A sends a signal representing that the main memory device 40 is in the abnormal state (that is, a signal which represents a failure of the main memory device 40) to the data protection unit 60B (FIG. 3: Step S305).

As a result of the above-mentioned determining, when the frequency of occurrence does not exceed the threshold (FIG. 3:“No” in Step S304), the memory monitoring and detection unit 60A continues to monitor the state of the main memory device 40 (FIG. 3: Step S301).

When the data protection unit 60B receives the signal from the memory monitoring and detection unit 60A, the data protection unit 60B identifies the present data write policy concerning the disk array 20 (FIG. 3: Step S306).

When the identified write policy is write-back (FIG. 3: “Yes” in Step S306), the data protection unit 60B executes processing of writing the written data 41 which is stored temporarily in the main memory device 40 (FIG. 3: Step S307).

Specifically, the preservation processing of the written data 41 is executed by writing the written data 41 accumulated in the cache memory 40A of the main memory device 40 to the disk array 20 (FIG. 3: Step S307).

When the data protection unit 60B completes processing of writing, the data protection unit 60B changes (that is, switches) the write policy to write-through. In addition, the data protection unit 60B sends a signal representing the change of the write policy to the notification unit 60C (FIG. 3: Step S308).

When the notification unit 60C receives the signal, the notification unit 60C notifies the upper level device or the administrator of the change in the write policy (FIG. 3: Step S309).

As a result of the above-mentioned identifying, when the present write policy is identified to be write-back (FIG. 3:“No” in S306), the data protection unit 60B keeps the write policy write-through.

The operation of the data preservation system 10 including, instead of the data preservation processing unit 60, the data preservation processing device 61 shown in FIG. 2 outside the main control device 50 is also same as the above-described operation.

Steps in Steps S301-S309 shown in FIG. 3 may be realized by a control program which controls a computer to carry out those steps. The series of the steps may be carried out by the computer which executes the control program.

### Advantageous Effects of the First Exemplary Embodiment

In the exemplary embodiment, in particular, by the data preservation processing unit 60 (data preservation processing device 61) functioning effectively, even when a 2 bits error occurs in the main memory device 40, loss of the write data can be suppressed. That is, the written data 41 which is stored temporarily in the main memory device 40 is preserved by the processing of writing (that is, save processing)in the disk array 20. That is, the written data 41 which is stored temporarily in the main memory device 40 is written in the disk array 20 and then does not exist anymore in the main memory device 40. By changing the write policy to write-through, the written data 41 inputted from outside is written in the disk array 20 directly after the write policy is changed. Accordingly, after the change in the write policy, even when a 2 bits error occurs in the main memory device 40, loss of the written data can be suppressed.

That is, by the RAID controller 30, or the data preservation processing system 10 or the like which includes the RAID controller 30 according to this exemplary embodiment, the data preservation processing according to a state of occurrence of a bit error, such as, a 1 bit error, a 2 bits error, and a plural bit error, can be realized effectively. As a result, it is possible to avoid data loss.

The data preservation processing system 10 is realized by applying a function which the existing RAID controller originally has. Therefore, the structure according to the data preservation processing unit 60 can be adopted for a product of RAID controller which is already shipped to the market. Thereby an effective data preservation processing can be realized.

The disk array 20 is realized by combining a plurality of hard disks on the basis of the technology of RAID. Even when a storage device, which may have comparatively large writable volume, is adopted instead of the disk array 20, the data preservation processing unit 60 (and data preservation processing device 61) also functions effectively for the storage device. Therefore, the data preservation processing system 10 can also carry out the data preservation processing for the storage device meaningfully.

### Second Exemplary Embodiment

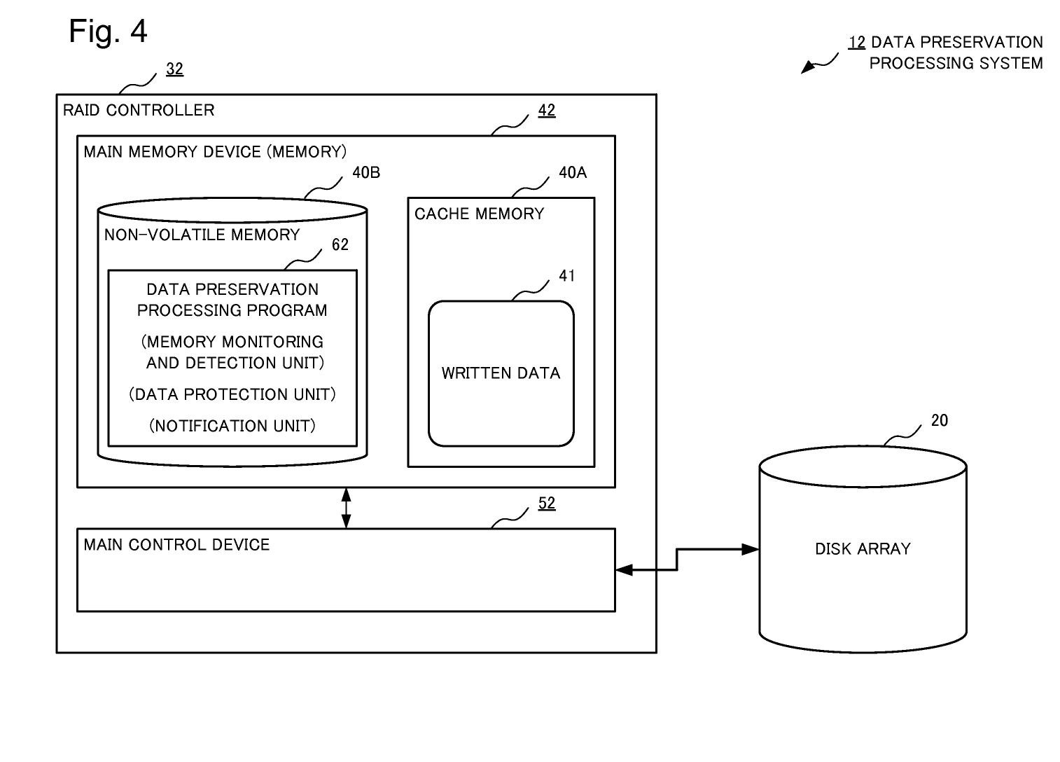

Next, a RAID controller and a data preservation processing system including the RAID controller according to a second exemplary embodiment of the present invention will be explained on the basis of FIG. 4 to FIG. 7. In the following explanation, an identical code is used to a component identical with a component of the first exemplary embodiment mentioned above, and a duplicated explanation for such component will be omitted.

As shown in FIG. 4, in a data preservation processing system 12 according to this second exemplary embodiment, a RAID controller 32 functions, for example, by firmware, in the same way as the data preservation processing unit 60 according to the above-described first exemplary embodiment. Specifically, a main memory device 42 includes the cache memory 40A and a non-volatile memory 40B such as a ROM or a flash memory. In this non-volatile memory 40B, a data preservation processing program 62 is stored in advance, for example, as at least part of the firmware.

A main control device 52, which makes the disk array 20 function as RAID and executes various kinds of data processing and the like, loads the data preservation processing program 62 in a RAM or the like (not illustrated). The data preservation processing program 62 makes a computer which the main control device 52 includes function in the same way as the memory monitoring and detection unit 60A, the data protection unit 60B and the notification unit 60C in the above-described first exemplary embodiment. As a result, preservation processing of the written data 41 which is inputted from outside and accumulated in the cache memory 40A is realized effectively. The main control device 52 may be the computer which executes the data preservation processing program 62. In the following explanation, the situation where the computer which the main control device 52 includes executes the data preservation processing program 62 is also described as “the main control device 52 executes the data preservation processing program 62.”

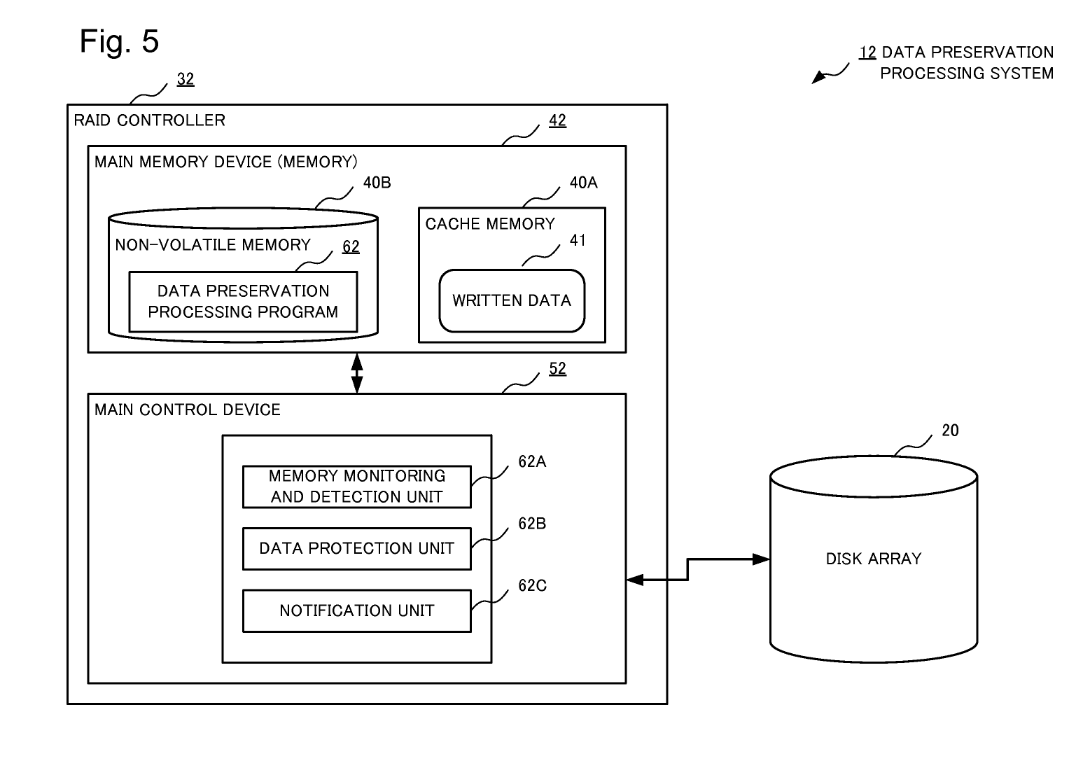

FIG. 5 to FIG. 7 illustrate states in which the main control device 52 is executing the data preservation processing program 62 which is read in the main control device 52.

By executing the data preservation processing program 62 which is read from the non-volatile memory 40B, the main control device 52 functions in the same way as the memory monitoring and detection unit 60A, the data protection unit 60B and the notification unit 60C in the above-described first exemplary embodiment. The main control device 52 which read the data preservation processing program 62 can function as the memory monitoring and detection unit 62A, the data protection unit 62B and the notification unit 62C.

Each of the other components is the same as the component with the same name in the data preservation processing system 10 of the above-described first exemplary embodiment.

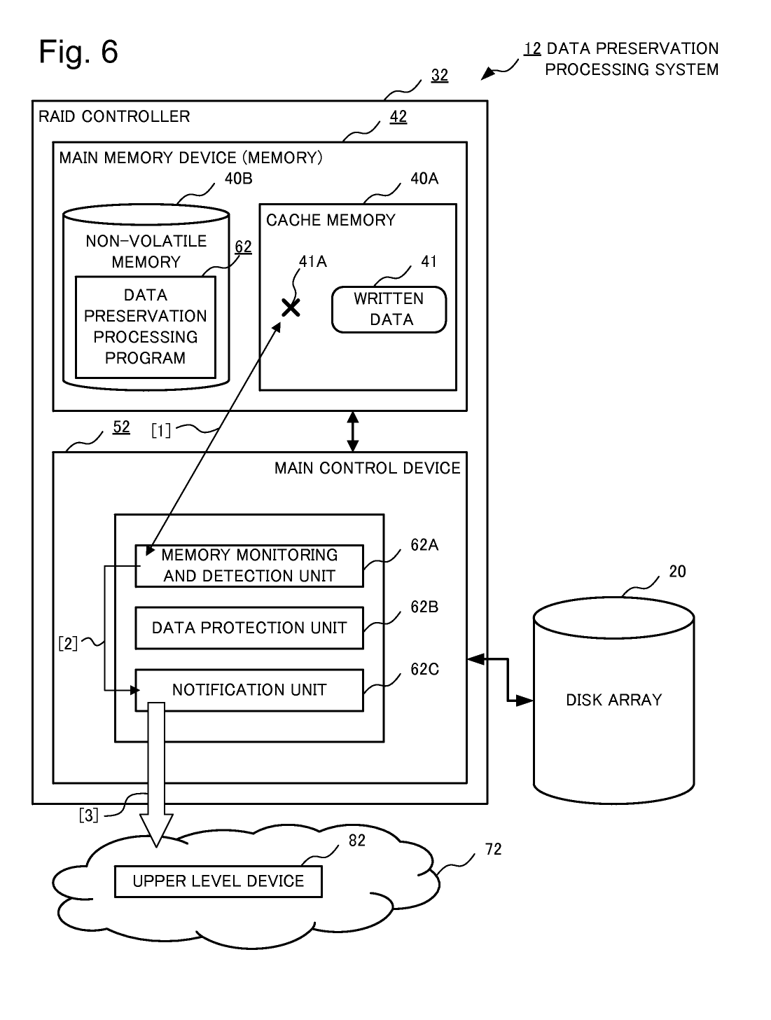

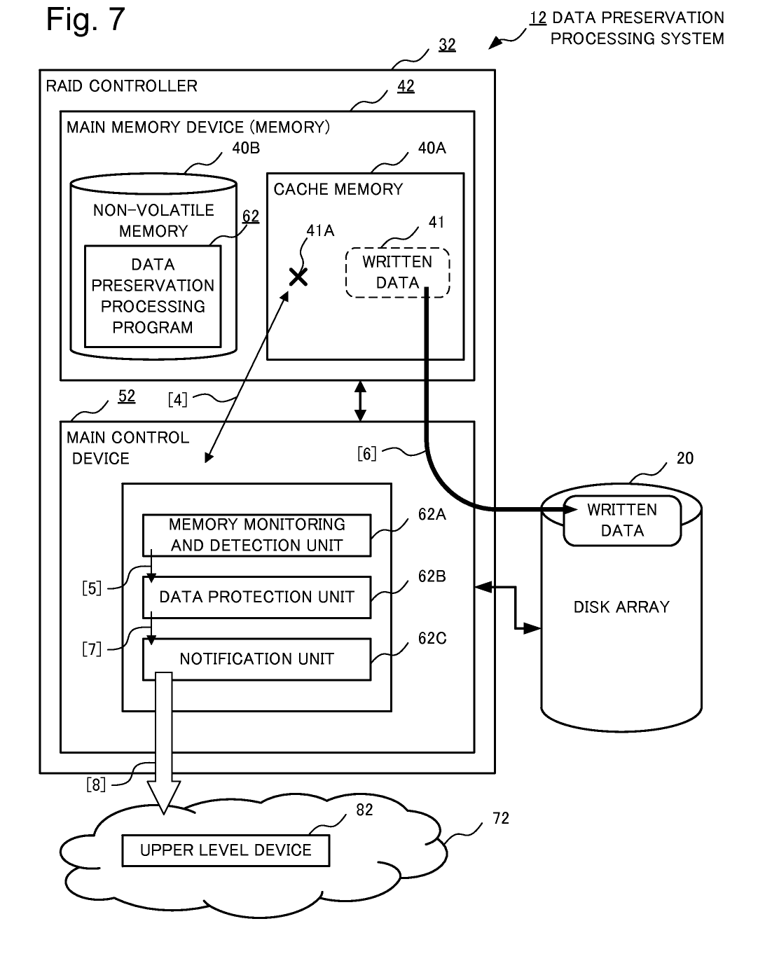

Arrows [1] to [3] shown in FIG. 6 relate to operation when the main control device 52 detects a 1 bit error by functioning as the memory monitoring and detection unit 62A. Arrows [4] to [7] shown in FIG. 7 relate to operation when the main control device 52 detects a failure of the main memory device 42 by functioning as the data protection unit 62B.

The main control device 52 which functions as the memory monitoring and detection unit 62A monitors a state of the main memory device 42. During monitoring of the state of the main memory device 42, when occurrence of a 1 bit error 41A in the cache memory 40A is detected (FIG. 6: arrow [1]), the main control device 52 functions as the notification unit 62C next. In FIG. 6 and FIG. 7, the 1 bit error 41A is schematically illustrated as an “x” mark. The main control device 52 which functions as the notification unit 62C notifies an upper level device (upper level SW) 82 or an administrator (not illustrated) which exists on a network 72 of the occurrence of the 1 bit error 41A (FIG. 6: arrows [2] and [3]).

The main control device 52 which detects the occurrence of the 1 bit error 41A then functions as the memory monitoring and detection unit 62A. The main control device 52 which functions as the memory monitoring and detection unit 62A monitors a frequency of occurrence of the 1 bit error 41A (FIG. 7: arrow [4]). When the frequency of occurrence obtained by the monitoring exceeds a predetermined threshold, the main control device 52 estimates that the main memory device 40 is in an abnormal state (that is, in failure) (FIG. 7: arrow [5]).

According to the estimation that the main memory device 40 is in the abnormal state, the main control device 52 functions as the data protection unit 62B. The main control device 52 which functions as the data protection unit 62B identifies the present data write policy concerning the disk array 20. When the identified write policy is write-back, the main control device 52 writes the written data 41 which is stored temporarily in the main memory device 40 (specifically, in the cache memory 40A) in the disk array 20 (FIG. 7: arrow [6]). The main control device 52 changes the write policy to write-through. Next, the main control device 52 functions as the notification unit 62C. The main control device 52 which functions as the notification unit 62C notifies, for example, the upper level device 82 or the administrator connected to the network 72 of the change in the write policy (FIG. 7: arrows [7] and [8]).

The arrows [1] to [3] shown in FIG. 6 and the arrows [4] to [8] shown in FIG. 7 relate to the operation of the data preservation processing system 10 according to the above-described first exemplary embodiment (FIG. 3: Steps S301-S309). Similarly, the other operations of the data preservation processing system 12 which is not explained above are the same as the related operations of the data preservation processing system 10 according to the first exemplary embodiment, respectively.

That is, the data preservation processing program 62 makes a computer which the main control device 52 includes function so that each step in above-described Steps S301-S309 (FIG. 3) is executed

### Advantageous Effects of the Second Exemplary Embodiment

In this exemplary embodiment, the main control device 52 reads the data preservation processing program 62 stored in the RAID controller 32 as at least part of the firmware. By the main control device 52 which executes the read data preservation processing program 62 functioning effectively, the main control device 52 can save, in the disk array 20, the written data 41 which is stored temporarily in the main memory device 42 as required. After a failure occurs in the main memory device 42, the main control device 52 changes the write policy to write-through so that the written data 41 inputted from outside is written in the disk array 20 directly. Therefore, even when the situation arises that a 2 bits error occurs in the main memory device 42, loss of the written data 41 can be suppressed.

That is, by the RAID controller 32 or the data preservation processing system 12 and the like including the RAID controller 32 according to this second exemplary embodiment, the data preservation processing according to in particular the occurrence a state of occurrence of a bit error can be realized effectively. As a result, it is possible to avoid data loss.

The data preservation processing system 12 is realized by applying the function which the existing RAID controller originally has. Therefore, the data preservation processing program 62 can be adopted for a product of RAID controller which is already shipped to the market. As a result, an effective data preservation processing can be realized.

The other effects are the same as those of the above-described first exemplary embodiment.

In the exemplary embodiment, the non-volatile memory 40B which stores the data preservation processing program 62 is included in the main memory device 42. This non-volatile memory 40B may exist in a different area in the RAID controller 32.

### Third Exemplary Embodiment

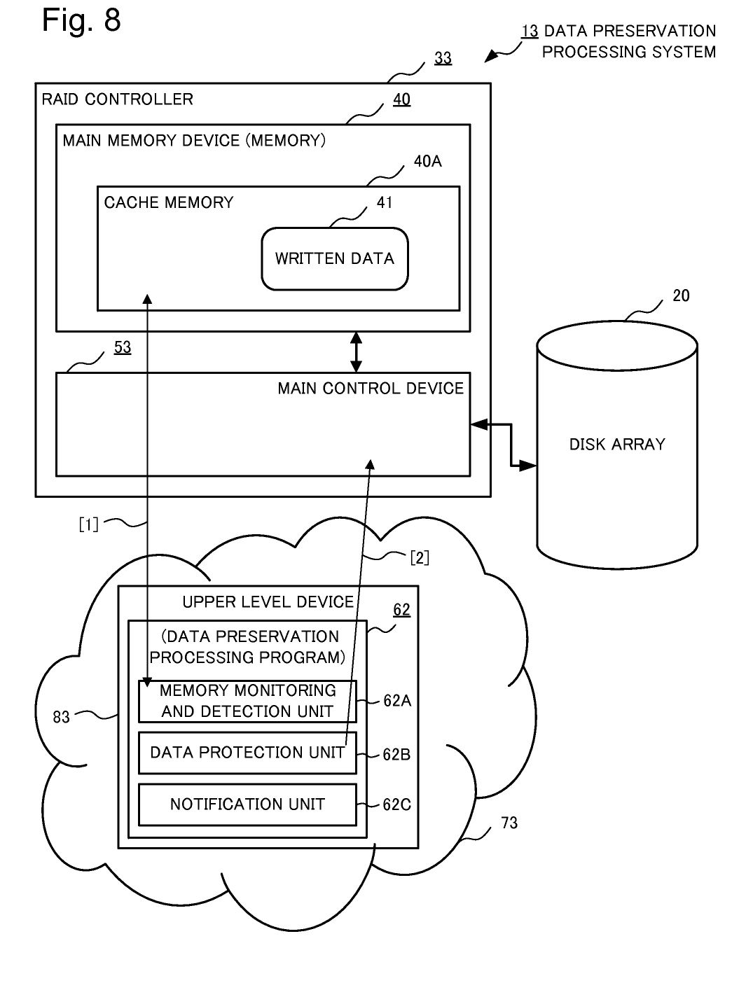

Next, a RAID controller and a data preservation processing system including the RAID controller according to a third exemplary embodiment of the present invention will be explained on the basis of FIG. 8. An identical code is assigned to a component identical with the component which is included in the first exemplary embodiment or the second exemplary embodiment, which are described above. During a normal operation, the RAID controller's write policy concerning the disk array 20 is write-back. As shown in FIG. 8, the written data 41 is stored temporarily in the cache memory 40A.

As shown in FIG. 8, in a data preservation processing system 13 according to the third exemplary embodiment, an upper level device (or a device in which upper level SW operates) 83, such as a host computer or a server, is connected to a RAID controller 33 via a network 73 which is a communication network. The upper level device 83 includes the data preservation processing program 62. Specifically, the upper level device 83 includes a storage area in which the data preservation processing program 62 is stored. The data preservation processing program 62 of the exemplary embodiment has the same function as that of the data preservation processing program 62, which is software for the RAID controllers 33, according to the above-mentioned second exemplary embodiment.

The data preservation processing program 62 stored in the storage area included in the upper level device 83 is executed by a computer which the upper level device 83 includes. Accordingly, the data preservation processing program 62 makes the computer which the upper level device 83 includes function as the memory monitoring and detection unit 62A, the data protection unit 62B and the notification unit 62C. The upper level device 83 may be the computer which executes the data preservation processing program 62. In the following explanation, a situation where the computer which the upper level device 83 includes executes the data preservation processing program 62 is also described as “the upper level device 83 executes the data preservation processing program 62,”

By functioning as the memory monitoring and detection unit 62A, the upper level device 83 detects a 1 bit error which occurs in the main memory device 40. The upper level device 83 monitors a frequency of occurrence of 1 bit errors. When the frequency of occurrence exceeds a predetermined threshold, the upper level device 83 detects the main memory device 40 being in an abnormal state (FIG. 8: arrow [1]).

When the main memory device 40 is detected to be in the abnormal state, the upper level device 83 identifies the write policy concerning the disk array 20 by functioning as the data protection unit 62B. When the identified write policy is write-back, the upper level device 83 changes the write policy to write-through. The upper level device 83 further issues instructions to save the written data 41 in the disk array 20 to the main control device 53 (FIG. 8: arrow [2]).

The other structures and operations of the exemplary embodiment are the same as the related structures and operations of the above-described first and the second exemplary embodiment.

As described above, the data preservation processing program 62 of the exemplary embodiment makes the computer which the upper level device 83 includes function so that each step in above-described Steps S301-S309 (in FIG. 3) is carried out via the network 72.

### Advantageous Effects of the Third Exemplary Embodiment

In the exemplary embodiment, the upper level device 83 such as a host computer or a server, which is connected with the RAID controller 33 via the network 73, includes the data preservation processing program 62. The upper level device 83 executes the data preservation processing program 62. By effective operation of the upper level device 83 which executes the data preservation processing program 62, the written data 41 which is stored temporarily in the main memory device 40 can be saved in the disk array 20 according to the frequency of occurrence of bit errors. By the upper level device 83, the write policy is changed to write-through after a failure in the main memory device 40 occurs so that the written data 41 inputted from outside is written to the disk array 20 directly. Therefore, loss of the written data 41 can be avoided before the situation in which a 2 bits error occurs in the main memory device 40 arises.

The data preservation processing system 13 is realized by applying the function which the existing RAID controller originally has. Therefore, the data preservation processing program 62 can be adopted for a product of RAID controller which is already shipped to the market. Thereby effective data preservation processing can be realized.

The other effects are the same as those of the above-described first and the second exemplary embodiment.

### Fourth Exemplary Embodiment

Next, a fourth exemplary embodiment of the present invention will be explained in detail with reference to drawings.

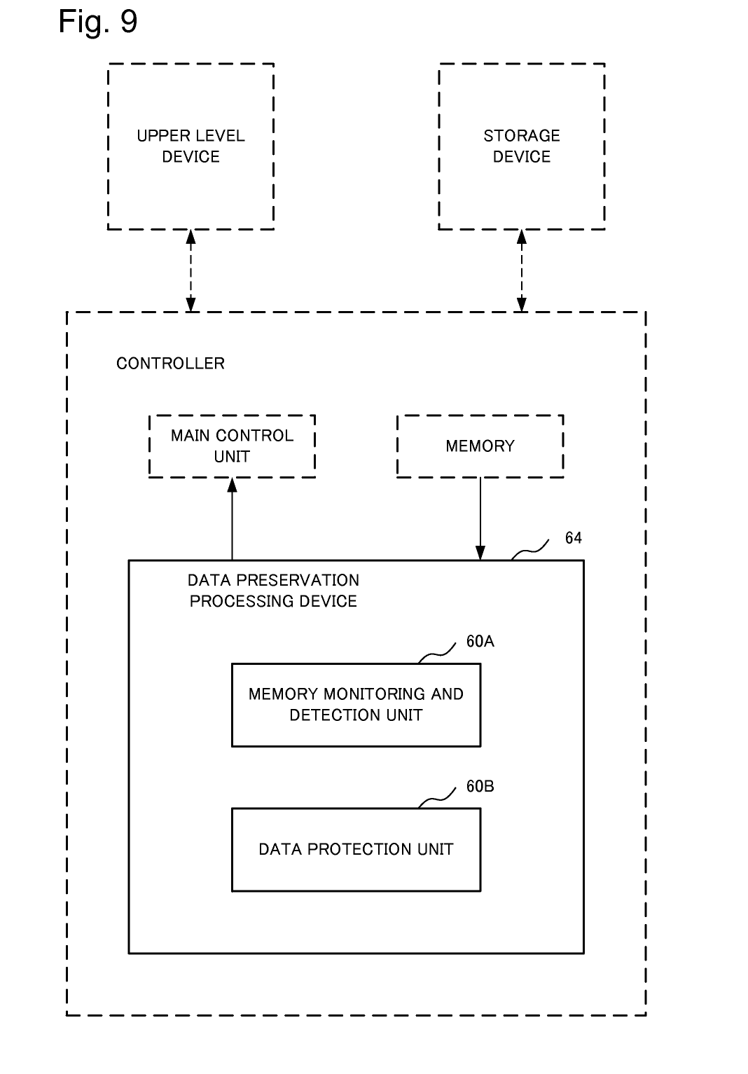

FIG. 9 is a block diagram illustrating an example of a structure of a data preservation processing device 64 according to the exemplary embodiment. Referring to FIG. 9, the data preservation processing device 64 of this exemplary embodiment includes: a memory monitoring and detection unit 60A which detects a memory being in an abnormal state, the memory being included in a controller which is communicably connected with a storage device and temporarily storing data which is inputted in the storage device; and a data protection unit 60B which changes a writing method concerning the storage device to write through when the memory monitoring and detection unit 60A detects the memory being in the abnormal state.

### Advantageous Effects of the Fourth Exemplary Embodiment

The data preservation processing device 64 of this exemplary embodiment has a effect that the data preservation processing according to the status of occurrence of a bit error can be realized effectively. The reason is because, when the memory monitoring and detection unit 60A detects the memory which the RAID controller includes being in the abnormal state, the data protection unit 60B changes the write policy concerning the disk array by the RAID controller to write-through.

### Other Exemplary Embodiments

The data preservation processing device 61, the RAID controller 32, the upper level device 83 and the data preservation processing device 64 can be realized by a computer and a program which controls the computer, special-purpose hardware, or a combination of the computer and the program which controls the computer and the special-purpose hardware respectively.

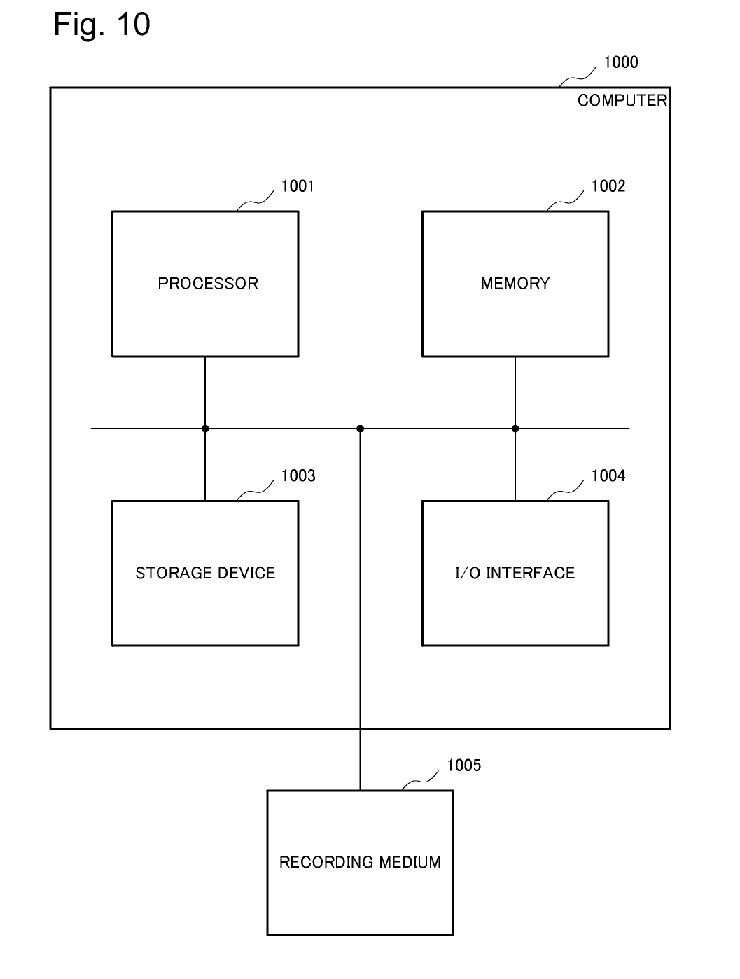

FIG. 10 is a figure illustrating an example of a structure of a computer 1000 which can realize the data preservation processing device 61, the RAID controller 32, the upper level device 83 and the data preservation processing device 64. Referring to FIG. 10, the computer 1000 includes a processor 1001, a memory 1002, a storing device 1003 and an I/O (Input/Output) interface 1004. The computer 1000 can access a recording medium 1005. Either of the memory 1002 and the storing device 1003 is a storing device such as a RAM (Random

Access Memory), or a hard disk. The recording media 1005 is a storing device such as a RAM, or a hard disk, a ROM (Read Only Memory) and a portable recording medium. The storing device 1003 may be the recording medium 1005. The processor 1001 can carry out reading and writing of data and a program in the memory 1002 and the storing device 1003. The processor 1001 can access via the I/O interface 1004 the disk array 20, the upper level device 83, and/or the RAID controller 33, for example. The processor 1001 can access the recording medium 1005. A program which make the computer 1000 operate as the data preservation processing device 61, the RAID controller 32, the upper level device 83, or the data preservation processing device 64 is stored in the recording medium 1005.

The processor 1001 loads, in the memory 1002, the program which is stored in the recording medium 1005 and makes the computer 1000 operate as the data preservation processing device 61, the RAID controller 32, the upper level device 83, or the data preservation processing device 64. By the processor 1001 executing the program loaded in the memory 1002, the computer 1000 operates as the data preservation processing device 61, the RAID controller 32, the data preservation processing device 64, or the upper level device 82.

The memory monitoring and detection unit 60A, the data protection unit 60B, the notification unit 60C, the memory monitoring and detection unit 62A, the data protection unit 62B, and the notification unit 62C can be realized, for example, by special purpose program which can realize the functions of each of the units and the processor 1001 which executes the program, where the special purpose program is loaded in the memory 1002 from the recording medium 1005 which stores the program. Or, part or all of the memory monitoring and detection unit 60A, the data protection unit 60B, the notification unit 60C, the memory monitoring and detection unit 62A, the data protection unit 62B, and the notification unit 62C can be realized by a special purpose circuit which realizes the functions of each unit.

In the control method disclosed by Patent document 1, when the main power source stops supplying power, the battery of the device, to which the main power source supplied power, supplies power to components of the device. And saving data is carried out using the power supplied by the battery. However, a technology to guarantee data when malfunction occurs in the components is not disclosed in Patent document 1.

The technology disclosed in Patent document 2 is, as mentioned above, the technology to carry out copying data when one of the memory controllers is detected being unavailable. Therefore, the technology disclosed in Patent document 2 is not able to cope with a situation where malfunction occurs in the cache memory which is included in at least one of the memory controllers.

In the above-mentioned technologies in Patent documents 1 and 2, when 1 bit error occurs in the cache memory, data which is cached in the cache memory is protected by the ECC function and hardware exchange, for example, in an environment where the write policy concerning the disk array is write-back. However, when occurrence of the 1 bit error is caused by malfunction of the cache memory itself, the malfunction often proceeds to the state where a 2 bits error occurs in the cache memory. In case the malfunction proceeds to the state where a 2 bits error occurs in the cache memory before the hardware exchange is implemented, the cache data is lost.

On the contrary, an exemplary advantage according to the above-described embodiments of the present invention is that it is able to realize effectively the data preservation processing depending on an occurrence state of a bit error.

While the present invention has been particularly shown and described with reference to exemplary embodiments thereof, the present invention is not limited to these exemplary embodiments. It would be understood by those of ordinary skill in the art that various changes in form and details may be made therein without departing from the spirit and scope of the present invention as defined by the claims.

The above-described exemplary embodiments are suitable specific examples of the data preservation processing device, the RAID controller, the data preservation processing system, the data preservation processing method and the program thereof. There are also cases in which technically desirable various limitations may be appended to those exemplary embodiments. However, as far as there is no description which limits the present invention in particular, the technological scope of the present invention is not limited to those aspects.

Although the followings are summaries of new technical contents about the above-described exemplary embodiments, the present invention is not limited by them.

(Supplementary Note 1)

A data preservation processing device monitoring a RAID controller which makes a disk array in which hard disks are combined function as RAID and executing preservation processing for data which is inputted from outside and is stored temporarily in a memory being included in the RAID controller, the data preservation processing device being characterized by including:

a memory monitoring and detection unit which detects a bit error occurring in the memory, monitors a frequency of occurrence of bit errors, and detects an abnormal state by estimating that the memory is in the abnormal state when the frequency exceeds a predetermined threshold; and

a data protection unit which changes a write policy concerning the disk array to wright through if the write policy is right back when the memory monitoring and detection unit detects the abnormal state.

(Supplementary Note 2)

The data preservation processing device according to supplementary note 1, wherein

the data protection unit saves, in the disk array, the data which is stored temporarily in the memory, after the memory monitoring and detection unit detects the abnormal state and before the write policy is changed.

(Supplementary Note 3)

A data preservation processing system including a disk array in which hard disks are combined, a RAID controller which makes the disk array function as RAID and a data preservation processing device which executes preservation processing for data which is inputted from outside and is stored temporarily in a memory being included in the RAID controller, wherein

the data preservation processing system includes as the data preservation processing device the data preservation processing device according to supplementary note 1 or 2.

(Supplementary Note 4)

A RAID controller including a memory in which data inputted from outside is stored temporarily and a main control device which makes a disk array in which hard disks are combined function as RAID, including:

a data preservation processing unit which monitors the memory and executes preservation processing for the data stored temporarily in the memory, wherein

the data preservation processing unit includes:

a memory monitoring and detection unit which detects a bit error which occurs in the memory, monitors a frequency of occurrence of bit errors, and detects an abnormal state by estimating that the memory is in the abnormal state when the frequency of occurrence exceeds a predetermined threshold; and

a data protection unit which changes a write policy concerning the disk array to write-through if the write policy is write-back when the memory monitoring and detection unit detects the abnormal state.

(Supplementary Note 5)

The RAID controller according to supplementary note 4, wherein the data preservation processing unit is included in the main control device.

(Supplementary Note 6)

The RAID controller according to supplementary note 4 or 5, wherein the data protection unit saves, in the disk array, the data which is stored temporarily in the memory, after the memory monitoring and detection unit detects the abnormal state and before the write policy is changed.

(Supplementary Note 7)

The RAID controller according to any one of the supplementary notes 4 to 6, wherein

the data preservation processing unit further includes:

a policy change notification unit which, notifies an outside unit of a change of the write policy when the data protection unit changes the write policy.

(Supplementary Note 8)

The RAID controller according to any one of the supplementary notes 4 to 7, wherein

the data preservation processing unit further includes:

a detection result notification unit which notifies an outside unit of occurrence of a bit error when the memory monitoring and detection unit detects a bit error.

(Supplementary Note 9)

A data preservation processing system including a disk array in which hard disks are combined, a RAID controller which makes the disk array function as RAID and carries out data preservation processing using the disk array, wherein

the data preservation processing system includes, as the RAID controller, the RAID controller according to any one of the supplementary notes 4 to 8.

(Supplementary Note 10)

A data preservation processing method in a RAID controller including a memory in which data being inputted from outside is stored temporarily, and a main control device which makes a disk array in which hard disks are combined function as RAID, the main control device including a data preservation processing unit which monitors the memory and executes preservation processing of the data which is stored temporarily in the memory, comprising:

detecting a bit error which occurs in the memory;

monitoring a frequency of occurrence of bit errors in the memory after detecting the bit error;

detecting an abnormal state by estimating that the memory is in the abnormal state when the frequency of occurrence obtained by the monitoring exceeds a predetermined threshold; and

changing a write policy concerning the disk array to write-through if the write policy is write-back when detecting the abnormal state, wherein

the data preservation processing unit executes each process of the method one by one.

(Supplementary Note 11)

The data preservation processing method according to supplementary note 10, wherein

the data preservation processing unit saves, in the disk array, the data which is stored temporarily in the memory, before the write policy is changed.

(Supplementary Note 12)

A data preservation processing method of a data preservation processing device monitoring a RAID controller which makes a disk array in which hard disks are combined function as RAID and executing preservation processing of data which is inputted from outside and is stored temporarily in a memory which is included in the RAID controller, comprising:

detecting a bit error which occurs in the memory;

monitoring a frequency of occurrence of bit errors in the memory after detecting the bit error;

detecting an abnormal state by estimating that the memory is in the abnormal state when the frequency of occurrence obtained by the monitoring exceeds a predetermined threshold; and

changing a write policy to write-through if the write policy is write-back when detecting the abnormal state.

(Supplementary Note 13)

The data preservation processing method according to supplementary note 12, comprising:

saving, in the disk array, the data which is stored temporarily in the memory, before the write policy is changed.

(Supplementary Note 14)

A non-transitory computer-readable recording medium storing a data preservation processing program of a RAID controller including a memory in which data which is inputted from outside is stored temporarily, and a main control device making a disk array in which hard disks are combined function as RAID and executing preservation processing of data which is inputted from outside and is stored temporarily in the memory, the data preservation processing program making a computer included in the main control device function as:

a memory monitoring and detection unit which detects a bit error which occurs in the memory, monitors a frequency of occurrence of bit errors, and detects an abnormal state by estimating that the memory is in the abnormal state when the frequency of occurrence exceeds a predetermined threshold; and

a data protection unit which changes a write policy concerning the disk array to write-through if the write policy is write-back when the memory monitoring and detection unit detects the abnormal state.

(Supplementary Note 15)

The non-transitory computer-readable recording medium according to supplementary note 14, storing the data preservation processing program which makes the computer function as:

a data saving unit which saves, in the disk array, the data which is stored temporarily in the memory, before the write policy is changed by the data protection unit,.

(Supplementary Note 16)

A non-transitory computer-readable recording medium storing a data preservation processing program of a data preservation processing system including a disk array in which hard disks are combined, a RAID controller which makes the disk array function as RAID, and a data preservation processing device which executes, via a network, preservation processing of data which is inputted from outside and is stored temporarily in a memory which is included in the RAID controller, the data preservation processing program making a computer included in the data preservation processing device function as:

a memory monitoring and detection unit which detects a bit error which occurs in the memory, monitors a frequency of occurrence of bit errors, and detects an abnormal state by estimating that the memory is in the abnormal state when the frequency of occurrence exceeds a predetermined threshold; and

a data protection unit which changes a write policy to write-through if the write policy is write-back when the memory monitoring and detection unit detects the abnormal state.

(Supplementary Note 17)

The non-transitory computer-readable recording medium according to supplementary note 16, storing the data preservation processing program which makes the computer function as:

a data saving unit which saves, in the disk array, the data which is stored temporarily in the memory, before the write policy is changed by the data protection unit.

### INDUSTRIAL APPLICABILITY

The present invention is applicable to a field of storage which uses a cache memory or the like, the cache memory being related with a storage device, such as a disk array, which has a large writable volume.

1. A data preservation processing device comprising:
a memory monitoring and detection unit which detects a memory being in an abnormal state, the memory being included in a controller which is communicably connected with a storage device and temporarily storing data which is inputted in the storage device; and
a data protection unit which changes a write policy concerning the storage device to write-through when the memory monitoring and detection unit detects the memory being in the abnormal state.

2. The data preservation processing device according to claim 1, wherein
the memory monitoring and detection unit detects a bit error which occurs in the memory, monitors a frequency of occurrence of bit errors on a basis of a result of detecting the bit error, and detects the memory being in the abnormal state when the frequency of occurrence exceeds a predetermined threshold.

3. The data preservation processing device according to claim 1, wherein
the data protection unit saves, in the storage device, the data which is stored in the memory, after the memory monitoring and detection unit detects the memory being in the abnormal state and before the data protection unit changes the write policy to write-through.

4. The data preservation processing device according to claim 1, further comprising:
a notification unit which sends a notification of the write policy being changed, when the data protection unit changes the write policy.

5. The data preservation processing device according to claim 1, wherein
the data preservation processing device is communicably connected with the controller via a communication network.

6. The data preservation processing device according to claim 1, wherein
the storage device is a disk array in which hard disks are combined; and
the controller is a RAID controller which makes the disk array function on a basis of RAID (Redundant Arrays of Inexpensive Disks).

7. A RAID controller including the data preservation processing device according to claim 6, comprising:
the memory; and
a main control device which makes the disk array function on the basis of RAID.

8. The RAID controller according to claim 7, wherein
the main control device includes the data preservation processing device.

9. A data preservation processing system including the data preservation processing device according to claim 1, comprising:
the storage device; and
the controller.

10. A data preservation processing method comprising:
detecting a memory being in an abnormal state, the memory being included in a controller which is communicably connected with a storage device and temporarily storing data which is inputted in the storage device; and
changing a write policy concerning the storage device to write-through when detecting the memory being in the abnormal state.

11. The data preservation processing method according to claim 10 comprising:
detecting a bit error which occurs in the memory; monitoring a frequency of occurrence of bit errors on a basis of a result of the detecting the bit error; and detecting the memory being in the abnormal state when the frequency of occurrence exceeds a threshold.

12. The data preservation processing method according to claim 10 comprising:
saving, in the storage device, the data which is stored in the memory, after detecting the memory being in the abnormal state and before changing the write policy to write-through.

13. The data preservation processing method according to claim 10 comprising:
sending notification of the write policy being changed, when changing the write policy.

14. The data preservation processing method according to claim 10, wherein
the storage device is a disk array in which hard disks are combined; and
the controller is a RAID controller which makes the disk array function on a basis of RAID (Redundant Arrays of Inexpensive Disks).

15. A non-transitory computer-readable recording medium storing a data preservation processing program which makes a computer operate as:
a memory monitoring and detection unit which detects a memory being in an abnormal state, the memory being included in a controller which is communicably connected with a storage device and temporarily storing data which is inputted in the storage device; and
a data protection unit which changes a write policy concerning the storage device to write-through when the memory monitoring and detection unit detects the memory is in the abnormal state.

16. The non-transitory computer-readable recording medium according to claim 15 storing the data preservation processing program which makes a computer operate as:
the memory monitoring and detection unit which detects a bit error which occurs in the memory, monitors a frequency of occurrence of bit errors on a basis of a result of the detecting the bit error, and detects the memory being in the abnormal state when the frequency of occurrence exceeds a threshold.

17. The non-transitory computer-readable recording medium according to claim 15 storing the data preservation processing program which makes a computer operate as:
the data protection unit which, after the memory monitoring and detection unit detects the abnormal state, saves, into the storage device, the data which is stored in the memory, after the memory monitoring and detection unit detects the memory being in the abnormal state and before the data protection unit changes the write policy to write-through.

18. The non-transitory computer-readable recording medium according to claim 15 storing the data preservation processing program which makes a computer operate as:
a notification unit which sends notification of the write policy being changed, when the data protection unit changes the write policy to write-through.

19. The non-transitory computer-readable recording medium according to claim 15 storing the data preservation processing program, wherein
the storage device is a disk array in which hard disks are combined; and
the controller is a RAID controller which makes the disk array function on the basis of RAID (Redundant Arrays of Inexpensive Disks).
